(19) United States
(12) Patent Application Publication
(10) Pub. No.: US 2014/0091164 A1
(43) Pub. Date: Apr. 3, 2014

(54) DEVICE FOR THE IMPACT CRUSHING AND DISPENSING OF MATERIALS, IN PARTICULAR WOOD, IN SEVERAL FRACTIONS

(71) Applicant: Ralf Schaefer, Russingen (DE)

(72) Inventor: Ralf Schaefer, Russingen (DE)

(73) Assignee: ProActor Schutzrechtsverwaltungs GmbH

(21) Appl. No.: 14/112,164

(22) PCT Filed: May 2, 2012
(86) PCT No.: PCT/EP2012/058055

§ 371 Date: Dec. 17, 2013

(30) Foreign Application Priority Data
May 2, 2011 (DE) 10 2011 100 240.9

(51) Int. Cl. B02C 13/286; B02C 23/10

(52) U.S. Cl. CPC B02C 13/286; B02C 23/10
USPC 241/79

(57) ABSTRACT

An apparatus for crushing material, especially wood, comprising a main body, and an ejection box connected to the main body via an ejection opening, and a first conveying screw in the ejection box beneath the ejection opening for conveying the crushed material from the ejection box, characterized in that a first screen having a first mesh width is arranged beneath the ejection opening, which first screen extends from the ejection opening to the first conveying screw at an incline with respect to the horizontal, and that a sliding surface arranged in an inclined manner with respect to the horizontal or a second screen which has a second mesh width that is smaller than the first mesh width and which is inclined with respect to the horizontal is arranged beneath the first screen, which second screen extends from the main body to a second conveying screw which is arranged beneath the first conveying screw.

The invention relates to an apparatus for impact crushing and dispensing of materials, especially wood, in several fractions, according the preamble of claim 1.

It is known from the state of the art to process components which are composed of different materials such as metal parts, glass, rubber, wood, polymers, fibre materials and composite materials by means of powder-coated or plastic-coated aluminium profiles or the like in impact reactors, in which the components are crushed by impact stresses by means of impact elements which are accommodated in a rotor rotating at high speed in a cylindrical main body.

In this connection, a method and an apparatus are known from EP 0 859 693 B1 for the processing of components made of mixed materials, especially mixed synthetic materials, in which an impact reactor which is accommodated in cylindrical main body comprises a rotor that is rotatable by a drive motor. The rotor, which is adjustable in its height in the main body, consists of wear-proof steel and comprises detachably accommodated impact elements at its ends, which impact elements will crush the introduced components into fragments of different size produced by the impact stresses occurring during the impact, which fragments can subsequently be separated from one another. The aforementioned specification does not provide any indication of discharging the crushed particles by downstream stacked screens which are arranged directly downstream of the ejection opening of the impact reactor into several fractions of different particle sizes.

It is therefore an object of the present invention to provide a compact apparatus with which different materials can be crushed by impact stresses and can be output in different fractions.

This object is achieved in accordance with the invention by an apparatus with the features of claim 1.

Further features of the invention are described in the dependent claims.

In accordance with the invention, an apparatus for crushing material, especially wood, comprises an impact reactor which has a substantially cylindrical main body, in the closed interior space of which there rotates a rotor driven by a motor and comprising at least one impact element, which comes into contact with the wood and crushes it into part-constituents while generating a great transfer of momentum. The apparatus further comprises an ejection box which is connected to the interior space of the cylindrical main body via an ejection opening, and a first conveying screw arranged beneath the ejection opening for conveying the crushed material from the ejection box.

The apparatus in accordance with the invention is characterized in that a first screen having a first mesh width is arranged beneath the ejection opening, which first screen extends from the ejection opening to the first conveying screw at an incline with respect to the horizontal, and that a sliding surface arranged in an inclined manner with respect to the horizontal or a second screen which has a second mesh width that is smaller than the first mesh width and which is inclined with respect to the horizontal is arranged beneath the first screen. The sliding surface or the second screen extends from the second cylindrical main body to a second conveying screw which is arranged beneath the first conveying screw.

The invention leads to the advantage that the ejection box of the apparatus in accordance with the invention can be kept in a comparatively compact manner with respect to its dimensions because the required base area for the screens, which is determined by the vertical projection of the screens, will advantageously be reduced by the inclined arrangement of the same with respect to its effective screen surface.

The inclination of the first screen leads to the further advantage that particles remaining on said screen which do not pass downwardly through the screen meshes will slip in the direction towards the conveying screw as a result of their own weight and will thereby free up the screen surface in the region of the ejection opening for the subsequent mixture of particles exiting from the ejection opening. Clogging of the screen surface will advantageously be prevented in this manner. The aforementioned advantage is also provided by the second screen, which is preferably arranged at the same angle of inclination as the first screen on a plane beneath the first screen extending in parallel to the screen surface of the first screen.

Furthermore, the advantage is provided especially by providing the ejection box with the second screen that a finer fractioning of the crushed material can be provided directly if desired, which material will leave the impact reactor without additional screening devices arranged remotely from the impact reactor being required as in the state of the art, which screening devices need to be supplied with the material in a complex manner, e.g. via conveyor belts.

Alternatively, a sliding surface can be provided instead of the second screen, which sliding surface prevents the particles passing through the first screen from falling downwardly out of the ejection box, which particles will also be referred to below as undersize. Since the sliding surface which will preferably downwardly seal the collecting container in this case in a dust-proof manner will discharge all particles passing through the first screen to the second conveying screw, the entire undersize will enter the conveying screw in this embodiment of the invention, by means of which the production of dust will be reduced considerably in comparison with the use of an open collecting container disposed directly beneath the first screening surface.

In the preferred embodiment of the apparatus in accordance with the invention, the ejection opening can be closed off by a third screen which has a mesh width which is increased in comparison with the mesh width of the first screen.

The advantage is provided by using a third screen with a mesh width which is enlarged in comparison with the first screen and which closes off the ejection opening that in a continuous process only the material particles which were crushed in the aforementioned manner to a maximum size predetermined by the mesh width of the said screen will reach the ejection box through the third screen. The remaining material which has not yet been sufficiently crushed will remain for such a time in the impact chamber of the impact reactor and will be crushed there continuously for such a time until it also assumes a diameter which is smaller than the mesh width of the third screen.

It can also be provided alternatively or simultaneously to the use of a third screen that the ejection opening can be closed off by a flap or a slide, by means of which the possibility of a discontinuous transfer of the crushed material from the impact chamber into the ejection box is advantageously provided. This alternative embodiment comes with the advantage that the supplied quantity of crushed material into the ejection box can be controlled in order to regulate the quantity of crushed material to the first and/or second screen if desired. As a result, overflowing or overshooting of the screens and clogging of the conveying screws can effectively be prevented in this way. Furthermore, this alternative embodiment offers the additional advantage that the discharge of the crushed material from the impact chamber can be performed in a controlled manner on the basis of further parameters, e.g. on the basis of the humidity disposed in the crushed particles or in the impact chamber, which humidity must not be too high in order to prevent the formation of lumps and the resulting clogging of the screens.

It has further proved to be especially advantageous when a combination of third screen and a flap or a slide is used in order to enable discontinuous discharge of the material from the impact chamber to the ejection box.

It can further be provided in an advantageous further development of the apparatus in accordance with the invention that a sliding surface which is inclined with respect to the horizontal is arranged beneath the second screen, or several further screens are arranged which are inclined with respect to the horizontal and which are provided with a mesh width which is reduced in comparison with the mesh width of the second screen. The further screen or screens respectively extend from the cylindrical main body at the same angle of inclination as the first and second screen with respect to the further conveying screw which is preferably arranged directly beneath the second conveying screw. The conveying screws preferably extend in one and the same vertical plane, which especially extends parallel to the rotational axis of the rotor outside of the impact chamber.

This leads to the advantage that a fine fractioning of the crushed material can be performed in a single compact apparatus without any additional downstream separating devices, as is desirable for example in the crushing of a starting material for direct further processing of the individual fractions of the crushed material. Three screen fractions with a grain size in the range of 20 to 15 mm for example, 15 to 5 mm and 5 to 0 mm can be produced in one working cycle and with one and the same compact apparatus during the crushing of wood for the production of chipboards which is supplied to the impact chamber in form of coarse crushed wood pieces with a diameter of 20 to 50 cm for example. These three fractions can be supplied directly to the production process of chipboards as starting material for the different layers of the chipboards to be produced, which considerably reduces the production effort and therefore the production costs.

As already explained above in connection with the first screen, a sliding surface is arranged beneath the second or lowermost further screen which is inclined with respect to the horizontal and which extends from the cylindrical main body to a respective further conveying screw. A downward termination of the ejection box is advantageously formed in this manner. This configuration especially offers the further advantage that the entire undersize which has passed through the screens situated above will be guided via the inclined sliding surface into a screw trough in which the lowermost conveying screw rotates, by means of which the development of dust can additionally be reduced even further.

In accordance with a further embodiment of the invention, the first and/or the second conveying screw is rotatably mounted within a tubular screw trough which is opened on its upper side and in which screen openings are formed which have an opening size corresponding to the mesh width of the respectively adjacent screen. The use of a screw trough provided with screen openings comes with the advantage that particles of a smaller diameter in relationship to the mesh width of the screen which especially inadvertently reach the screw trough associated with the screen by transfer of the respective screen will still fall through the screen openings in the screen trough onto the screen situated beneath, or the screen trough situated beneath, and will thereby be discharged according to their size in the correct screen fraction. This is additionally promoted by the rotating conveying movement of the screws in the screw trough and the resulting mixing and circulation of the particles in the screw trough.

The conveying and circulating movement of the material within the screw troughs provided at least partly on the bottom side with openings leads to the further advantage that particles which adhere to one another only loosely or are connected to one another at a comparatively narrow connecting point will be separated from one another by the conveying movement and the resulting mechanical friction and will subsequently reach the screens or conveying screws situated underneath through the screen openings according to their size.

In accordance with a further embodiment of the apparatus in accordance with the invention it may be advantageous when the third screen has a mesh width in the range of 20 mm, the first screen a mesh width in the range of 15 mm and the second screen a mesh width in the range of 5 mm. An even fractioning with respective size ranges is advantageously achieved in this manner, as is required for example by the wood-processing industry for the production of chipboard materials such as pressboards for example. The wood particles must be present in various sizes in order to provide a chipboard with the smoothest possible surface on the one hand and high strength on the other hand. For this purpose, preferably larger and flatter particles are used in the middle layer which absorbs the load, which particles ensure a more constant flat distribution of the forces acting on the board. The smallest possible particles are applied to the upper and bottom side of the chipboards for producing the smooth cover layer.

A deviating allocation of the mesh widths of the screens can also occur alternatively, so that by approaching the mesh widths of the first and second screen the sorting purity of the material particles will be increased for example by a resulting reduction in the statistical fraction of the particles which are too large or too small and which are undesirable in the respective size range. Furthermore, the quantity of particles above the desired range can further also be reduced by a reduction and the resulting approximation of the mesh widths of the third screen to the mesh width of the first screen, because the particles will remain longer in the impact chamber in order to be sufficiently crushed on the one hand and the fraction of excessively large particles in the particle mixture passing through the third screen will be reduced by a narrower range between the mesh widths of the first and third screen on the other hand.

In accordance with a further idea on which the invention is based, horizontally extending barrier strips can be arranged on the first screen, which barrier strips will reduce the speed of the crushed material exiting from the ejection opening during its movement along the inclined screen. The resulting advantage is that the residual fraction of smaller particles will be minimised in the particle mixture discharged by the first conveying screw, because the dwell time on the first screen will be increased by the barrier strips. This will generally allow a more precise separation of the particles from a quality standpoint by the first screen because the likelihood of overshooting the screen will be reduced as a result of the longer dwell time.

The first and/or the second screen respectively comprise a screen plate or an effective screen area in the preferred embodiment of the invention, which is inclined with respect to the horizontal at an angle in the range of 20° and 70°, especially in the range of 30° to 45°, and which can advantageously be changed within these limits.

This leads to the possibility that a high ejection speed of the particles reaching the first screen via the ejection opening, which ejection speed may be required for the separation of material mixtures by a respective circumferential speed of the road for example, can be compensated by a respective choice of the inclination of the screen plate of the first screen. It may optionally even be required to align the first screen at an angle which is negative in relation to the other screens, so that particles passing through the ejection opening will impinge directly on the first screen arranged in an inclined manner at an angle of 45° for example and will subsequently slide downwardly in the direction towards the outside of the impact reactor onto the first screen plate. The first conveying screw is arranged in this case beneath the ejection opening in the region close to the exterior wall of the impact reactor, and the second screen is situated with the same direction of inclination or the opposite direction of inclination beneath the first screen in the manner as described above.

It can further be provided that the first and/or the second screen and/or optionally the further screen comprises one or several unbalanced motors, by means of which the respective screen can be made to vibrate. In this respect, the first and second screen is preferably fixed by means of vibration-dampened spring-elastic suspensions or buffers to the circumferential surfaces of the ejection box and are made to vibrate for example via a flywheel mass which is coupled with the respective screen, made to rotate by a motor and is eccentrically mounted.

The excitation of the first and second screen into vibrations advantageously leads to the consequence that the particle mixture will be fluidised on the respective screen, by means of which the larger particles on the screen will travel upwardly and the smaller particles will travel downwardly in the case of a respective selection of the vibrating frequency and the type of vibrations, which additionally supports the screening process and improves the quality of the obtained fractions.

The invention will be described below by reference to a preferred embodiment shown in the drawings, wherein:

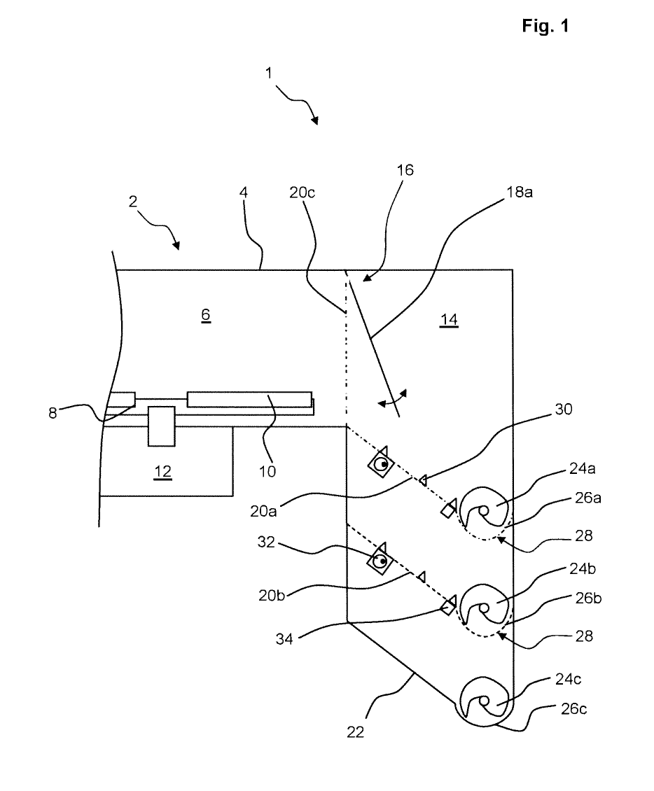

FIG. 1 shows a schematic side view of the apparatus in accordance with the invention;

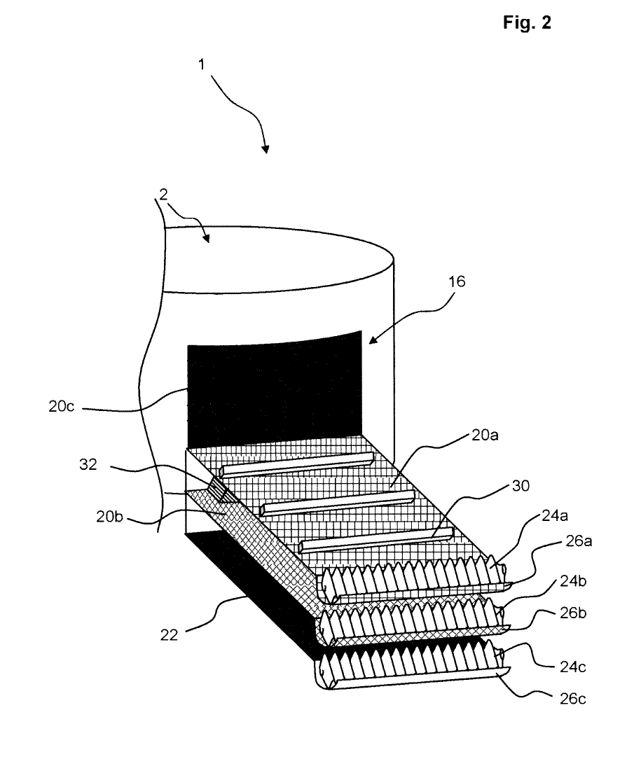

FIG. 2 shows a perspective view of the apparatus without the wall regions of the ejection box, and

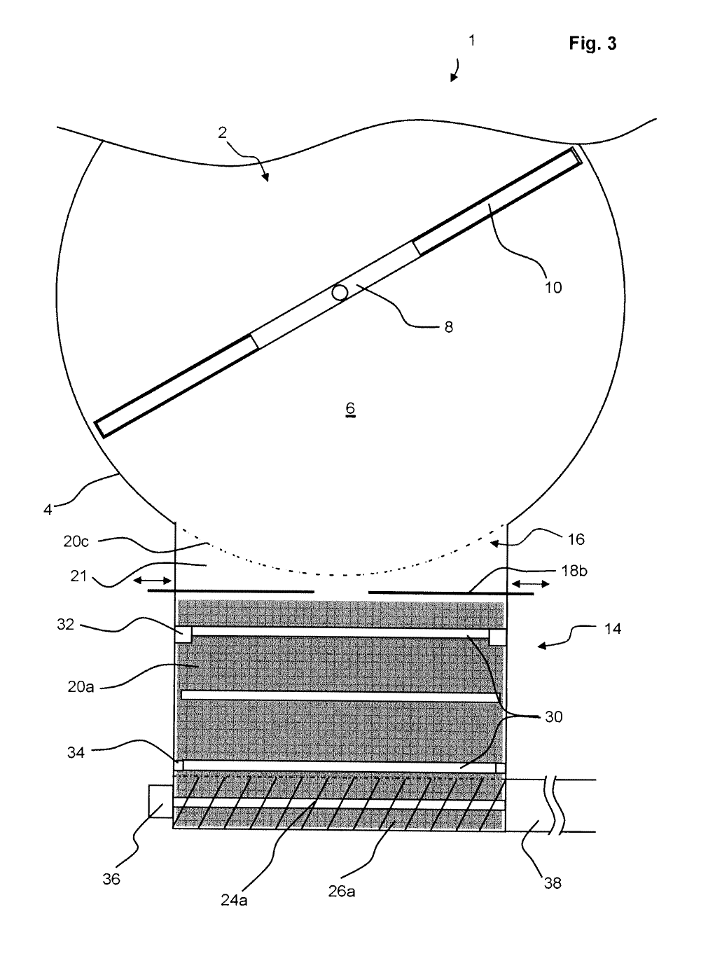

FIG. 3 shows a schematic top view of the apparatus in accordance with the invention.

As shown in FIG. 1, an apparatus 1 in accordance with the invention for crushing different materials such as wood, metals, plastic materials and mixtures and composites of these materials comprises an impact reactor 2 which has a substantially cylindrical main body 4, in the closed interior space 6 of which a rotor 8 rotates at high speed, on which several preferably exchangeable impact elements 10 made of a high-strength material are arranged. The drive of the rotor 8 occurs by way of a motor 12 which is preferably an electric motor, but can also be an internal combustion engine or the motor of a motor vehicle such as a tractor which drives the rotor 8 by a power take-off shaft and an angular gear (not shown in closer detail).

Furthermore, the apparatus 1 in accordance with the invention comprises an ejection box 14 which is sealed towards the exterior, which is arranged on the exterior wall of the cylindrical main body 4 and is in flow-connection with the interior space 6 of the cylindrical main body 4 via an ejection opening 16. In accordance with the preferred embodiment of the invention, the ejection opening 16 comprises a continuous third screen 20c with a mesh width of preferably 20 mm. The screen 20c can be covered by a flap 18a which can be folded along the shown double arrow for example or by a slide 18b in such a way that the ejection opening 16 is closed off in part or in full and the passage of crushed material will be prevented.

The third screen 20c which is inserted into the ejection opening 16 will fraction the particles flying around in the interior space 6 of the impact reactor 2, in that it allows particles with a size of less than the mesh width of the third screen 20c in the amount of preferably 20 mm to enter the ejection box 14 and retains larger particles and pieces of material not yet sufficiently crushed in the interior space 6 of the impact reactor 2 in order to supply them to a further crushing process. The flap 18a, which is shown in FIG. 1, will control the inflow of crushed particles into the ejection box 14 in that the flap 18a (or the two-part slide 18b shown in FIG. 3) will be locked in a partly opened position and therefore the relative pass-through area of the ejection opening 16 can be reduced continuously. It is alternatively also possible to supply the ejection box 14 by cycling opening and closing of the flap 18a or the slide 18b in batches with crushed material.

A first plane consisting of a first screen 20a with a first mesh width which is inclined relative to the horizontal is arranged within the ejection box 14 in the preferred embodiment of the apparatus 1 in accordance with the invention, which first screen extends from the bottom end of the ejection opening 16 to the first screw trough 26a which is arranged beneath the ejection opening 16 and in which a first conveying screw 24a is accommodated in order to convey the crushed material from the ejection box 14. The mesh width of the first screen 20a is preferably lower than the mesh width of the third screen 20c, by means of which a further fractioning of the crushed material according to the mesh width of preferably 50 mm occurs with said first plane. The particles whose diameter is smaller than 50 mm will fall through the meshes of the first screen 20a, wherein the particles with a size of between 15 and 20 mm remain above the first screen 20a and are guided in the downward direction up into the first screw trough 26a as a result of the inclination of the first screen 20a. They will be conveyed there by the first conveying screw 24a through an opening (not shown) to the side of the ejection box 14 in order to be supplied to further processing or storage.

As is further shown in closer detail in FIG. 1, the first screw trough 26a comprises screen openings 28 whose mesh width substantially corresponds to the mesh width of the first screen 20a. This allows particles which erroneously have reached the first screw trough 26a by overshooting the first screen 20a to pass through the screen openings 28 and to be still separated from the larger particles according to the mesh width of the first screen 20a.

The illustration of FIG. 1 further shows that a second screen plane which substantially corresponds to the configuration of the first screen plane is arranged beneath the first screen plane consisting of the first screen 20a and the first screw trough 26a, which second screen plane comprises a second screen 20b which is inclined with respect to the horizontal and a second screw trough 26b which contains a second conveying screw 24b. The second screen 20b has a second mesh width of preferably 5 mm, which is reduced in comparison with the mesh width of the first screen 20a of preferably 15 mm in order to separate the particles passing through the first screen 20a with a size in the range of 5 to 15 mm from such components which have a size of less than 5 mm. The particles remaining above the second screen 20b with a diameter in the range of 5 to 15 mm will be guided into the second screw trough 26b as a result of the inclination of the second screen 20b and will be conveyed out of the ejection box 14 there by the second conveying screw 24b. Screen openings are preferably also introduced into the bottom side of the second screw trough 26b which can consist of a tube in the same manner as the first screw trough 26a, which tube merely comprises an upwardly facing opening within the ejection box 14 in the connecting region of the screen plane and which screen openings have an opening width which substantially corresponds to the mesh width of the second screen 20b.

In accordance with a further idea on which the invention is based, the first and the second screen 20a, 20b comprise an unbalanced motor 32 on their bottom side (as shown in the illustration of FIG. 1), which motor is preferably in mechanical connection with the side walls of the ejection box 14 which are not shown for illustration reasons, by means of which the screens can be made to vibrate. The further shown vibration dampers or buffers 34, by means of which the first and the second screen 20a, 20b preferably rest on the side walls of the ejection box 14, are preferably arranged in the region of the edge facing the respective first and second screw trough 26a, 26b in order to mount the screens in a vibratory manner and to simultaneously reduce the vibration amplitude in the region of the first and second screw trough 26a, 26b. As a result, the vibrations of the screens will be decoupled from each other and also from the housing of the ejection box 14 which is enclosed towards the outside and from the conveying screws 24a, 24b, by means of which the vibration modes and amplitudes for the respective screen can be adjusted optimally to the material to be crushed. Furthermore, the remaining components such as especially the conveying screws will not be impaired by the vibrations, so that their operational lifespan will increase advantageously.

As is further shown in the illustration of FIG. 1, a sliding surface 22 which is inclined with respect to the horizontal is provided in the preferred embodiment of the invention beneath the second screen 20b, which sliding surface preferably also extends substantially parallel to the first and second screen 20a, 20b from the cylindrical main body 4 to a third conveying screw 24c which is arranged beneath the second conveying screw 24b and which is accommodated in a downwardly closed third screw trough 26c, i.e. a screw trough which in contrast to the screw troughs 26a and 26b does not comprise any screen openings 28. As a result of the closed sliding surface 22 in conjunction with the third screw trough 26c which is closed off on the bottom side, the finest material components which have passed through the first and the second screen 20a, 20b will be conveyed from the ejection box 14 into a collecting container (not shown in closer detail).

The second screen 24b preferably has the same angle of inclination with respect to the horizontal as the first screen 24a, which is advantageously variable and lies in the range of 30 to 50° for example.

The illustration of FIG. 2 shows a schematic spatial side view of the impact reactor with the ejection box 14, in which the side walls are not shown for the purpose of better illustration of the screen planes and where the different mesh widths are indicated by the different patterns of the first, second and third screen 20a, 20b, 20c. The illustration also shows that the barrier strips 30 extend over the entire width of the first screen 20a.

Furthermore, FIG. 3 shows a schematic top view of the apparatus 1 in accordance with the invention. This illustration shows in detail that the ejection opening 16 can be sealed by the slide 18b which comprises two slider parts and is shown in a partly opened position, in that the slider parts can be displaced along the two double arrows. It is also possible that the slide 18b is made of one single slider plate which can be displaced or pivoted for example by a vertical, upwardly directed sliding movement for example in order to open the ejection opening 16. The slide 18b can also have an arc shape adjusted to the curvature of the outside surface of the impact reactor 2 and can be displaceable in the circumferential direction or in the vertical direction in order to release the ejection opening 16.

The intermediate area 21 which is obtained as a result of the curvature of the outside wall of the impact reactor 2 and the preferably straight connecting edge of the first screen 20a is preferably arranged as a closed and inclined sliding surface, along which the crushed material which exits at low speed from the ejection opening 16 and which does not initially impinge on the screen surface of the first screen 20a is able to slide downwardly in the direction of first screen.

FIG. 3 further shows a conveying tube 38 by way of example in the axial extension of the first conveying screw 24a, which tube is accommodated on the exterior of the ejection box 14 in order to convey the material transported by the first conveying screw 24a to a collecting container for example which is not shown in closer detail. The conveying screw 24a will be driven by a screw motor 36 in the same manner as the aforementioned conveying screws, which screw motor is shown in this illustration only by way of example.

### LIST OF REFERENCE NUMERALS

1 Apparatus in accordance with the invention
2 Impact reactor
4 Main body
6 Interior space/impact chamber
8 Rotor
10 Impact element
12 Motor
14 Ejection box
16 Ejection opening
18a Flap
18b Slide
20a First screen
20b Second screen
20c Third screen
21 Intermediate area
22 Sliding surface
24a First conveying screw
24b Second conveying screw
24c Third conveying screw
26a First screw trough
26b Second screw trough
26c Third screw trough
28 Screen openings
30 Barrier strips
32 Unbalanced motor
34 Vibration damper
36 Screw motor
38 Conveying tube

1. An apparatus for crushing material, especially wood, comprising an impact reactor which has a substantially cylindrical main body, in the closed interior space of which there rotates a rotor with at least one impact element, which comes into contact with the material and crushes it into part-constituents while generating a great transfer of momentum, and an ejection box which is connected to the interior space of the cylindrical main body via an ejection opening, and a first conveying screw arranged in the ejection box beneath the ejection opening for conveying the crushed material from the ejection box, characterized in that a first screen having a first mesh width is arranged beneath the ejection opening, which first screen extends from the ejection opening to the first conveying screw at an incline with respect to the horizontal, and that a sliding surface arranged in an inclined manner with respect to the horizontal or a second screen which has a second mesh width that is smaller than the first mesh width and which is inclined with respect to the horizontal is arranged beneath the first screen, which second screen extends from the cylindrical main body to a second conveying screw which is arranged beneath the first conveying screw.

2. An apparatus according to claim 1, characterized in that the ejection opening can be sealed by a third screen with a mesh width which is enlarged in comparison with the mesh width of the first screen, and/or by a flap and/or a slide.

3. An apparatus according to claim 1, characterized in that a sliding surface which is inclined with respect to the horizontal or one or several screens which are inclined with respect to the horizontal and which have a mesh width which is reduced in comparison with the second mesh width are arranged beneath the second screen, which screens respectively extend from the cylindrical main body to the respective further conveying screws arranged beneath the second conveying screw.

4. An apparatus according to claim 1, characterized in that the first and/or the second conveying screw rotate in a tubular screw trough which is open on its upper side and in which screen openings are formed which have an opening size corresponding to the mesh width of the adjacent screen.

5. An apparatus according to claim 2, characterized in that the third screen has a mesh width in the range of 20 mm, the first screen has a mesh width in the range of 15 mm, and the second screen has a mesh width in the range of 5 mm.

6. An apparatus according to claim 1, characterized in that horizontally extending barrier strips are arranged on the first screen, which barrier strips reduce the speed of the crushed material exiting from the ejection opening during its movement along the inclined screen.

7. An apparatus according to claim 1, characterized in that the first and/or second screen respectively comprise a screen plate which is arranged in an inclined manner with respect to the horizontal at an angle in the range of between 20° and 70°, especially in the range of 30° to 45°.

8. An apparatus according to claim 3, characterized in that the first and/or the second screen and/or the further screen comprises unbalanced motors in order to make the respective screen vibrate.
